(19) United States
(12) Patent Application Publication
(10) Pub. No.: US 2007/0075150 A1
(43) Pub. Date: Apr. 5, 2007

(54) Item with an optical effect

(76) Inventors: Markus Luthi, Marthalen (CH); Matthias Reinhold, Neuhausen (CH); Rene Hauser, Zurich (CH)

Correspondence Address: FISHER, CHRISTEN & SABOL, 1725 K STREET, N.W., SUITE 1108, WASHINGTON, DC, 20006, US

(21) Appl. No.: 11/511,474

(22) Filed: Aug. 29, 2006

(30) Foreign Application Priority Data
Sep. 20, 2005 (EP) 05405548.8

(51) Int. Cl. G06K 19/06; G06K 19/00

(52) U.S. Cl. 235/494; 235/487

(57) ABSTRACT

An item with a surface area creating an optical effect to increase protection against forgery is such that the surface area with the optical effect exhibits at least two images (12, 14) spaced a distance (d) apart. A first image (12) is situated on the surface (11) of a layer of material (10) and the second image (14) is virtual and, by holographic coding, appears to lie a distance (d) from the first image (12). By changing the angle of viewing, the optical perception of the whole image formed by the overlapping of the images (12, 14) changes, whereby the images (12, 14) are matched with respect to each other such that they demonstrate Moiré interference effects. A preferred application for the item is packaging, packaging material, packaging aids, bonds or entry tickets with forgery-proof and/or optically demanding surface area.

The invention relates to an item with a surface area creating an optical effect to increase protection against forgery, whereby the surface area with the optical effect exhibits at least two images spaced a distance (d) apart and, by changing the angle of viewing, the optical perception of the whole image formed by the overlapping of the images changes, whereby a first image is situated on the surface of a layer of material and the images are matched with respect to each other such that they demonstrate Moiré interference effects.

Protection against forgery is of great importance, especially in the pharmaceutical industry. Basically, however, there is a demand for forgery-proof packaging or products also in other areas, especially in the consumer goods industry, for example for the packaging of foodstuffs, cosmetic items, clothes, software and music CDs or financial bonds. The item with the surface area intended to create an optical effect may be a form of packaging, auxiliary packaging means, or a product itself on which a surface area is provided with a security item with an optical effect e.g. a label.

Forgery-proof packaging or packaging aid may serve as guarantee of origin which enables the customer to recognise that the item he has purchased has in fact been produced and packaged by the desired manufacturer. A forgery-proof packaging aid may also be used as a guarantee of first opening, e.g. in the form of a label, strip or sealing strip etc. secured e.g. over a bottle closure or over a wide-necked glass, over the seam between the lid and a container or over the tear-open closure of a pouch. On opening the packaging in question the label, strip or sealing strip is destroyed, thus revealing that the packaging has already been opened. It is also possible to fill or place items into an outer packaging, whereby the outer packaging exhibits characteristically unmistakeable features which cannot therefore be copied, and which show that the packaging of the contents has been carried out by a particular supplier.

Known forgery-proof forms of packaging and products are provided with holograms on their surface or they exhibit colour codes or invisible features. In practice holograms, among various possibilities, have proved to be an effective means of achieving a high degree of proof against forgery. Examples thereof are hologram labels or lid films with integral holograms. The creation of individualised holograms, however, involves enormous costs.

The document U.S. Pat. No. 4,662,653 reveals an item with a surface area exhibiting a transparent layer with an image which borders on one side on a mirroring layer. The mirrored version of the image forms a second image, whereby the distance between these images is given by the thickness of the layer of material. On changing the angle of viewing there is a change in optical perception of the overall image created by overlapping the two images. The distance between the individual image elements or between the image and the reflecting layer, are chosen such that the optical effect is due to light diffraction.

Also U.S. Pat. No. 4,632,430 reveals items with a surface area creating an optical effect, whereby two images are kept a distance apart by a transparent layer and, by changing the angle of viewing, the optical perception of the overall image created by overlapping the images is changed. This effect which occurs only when light is shining through the item is based on a simple overlapping of the shadow regions two images.

An item known from EP-A-0 348 583 contains a base area with a line pattern. A transparent film with the second line pattern is attached partially to the base area such that, on moving the item, the distance between the base area and the transparent film change by different degrees. Under certain spatial conditions a kind of “dynamic” Moiré-pattern is observed by the viewer.

Revealed in WO-A-97/19820 is an item which exhibits an optical effect on its surface, resulting from the arrangement of two images that are separated by a layer of transparent material. The images, produced on a microscopic pattern by light diffraction, lead to Moiré interference patterns due to overlapping.

Known from WO-A-98/15418 is a bond which when folded exhibits an optical effect in a surface region, said effect being due to Moiré interference. Each image is deposited on a transparent film, whereby the images are not a fixed distance from each other; instead each image is independent of the other. The optical effect becomes visible therefore only when the images are placed one over the other on folding the paper.

Known from DE-A-31 20 653 are so-called Moiré strain gauges. The two images (scan films) are not held a fixed distance apart, but are independent of each other.

EP-A-1 089 883 reveals an item with a surface area that creates an optical effect for the purpose of increasing proof against forgery, whereby the surface area with the optical effect exhibits at least two images held a fixed distance from each other by a transparent layer of material and, by changing the angle of viewing, the optical perception of the overall image created by overlapping the two images is changed, whereby the distance between the images—defined by a thickness of the transparent material—and the distance between neighbouring image elements making up the images are arranged such that the images create Moiré interference effects.

The object of the invention is to provide at least a part of the surface of items such as forms of packaging, packing, packaging aids or products themselves with an optical effect that can be manufactured more cost favourably than individualised holograms and provides greater security against forgery than the optical effect known from EP-A-1 089 883 on the basis the creation of Moiré interference as a result of arranging images on both sides of a transparent layer of material.

That objective is achieved by way of the invention in which in an item of the kind mentioned at the start, as a result of holographic coding, the second image appears to lie a distance from the first image.

The holographic coding of the second image is preferably embossing or an etched hologram.

The invention makes use of the phenomenon known from EP-1 089 883 based on a three dimensional Moiré pattern. Moiré patterns are two dimensional images which are the result of two patterns lying one over the other. By displacing such two overlaid images the Moiré interference pattern also changes, resulting in the known changing light-dark effect. In the case of a three dimensional Moiré pattern the change in Moiré interference effect is achieved without mechanical displacement. By the separation of the two images a spatial arrangement is produced which, on changing the angle of viewing, results in changing Moiré interference patterns.

The essence of the invention lies in the production of a three dimensional Moiré pattern by superimposing a real image and a virtual image.

In order to create the effect according to the invention, the distances known from the Moiré patterns have to be observed between neighbouring image elements. The images may also be made up of individual parallel lines, dots or contain a combination of straight and curved lines or other images.

In the simplest case the holographic coded virtual image is a uniform linear pattern of parallel lines with equal distance between neighbouring individual lines and the real image a pattern which matches the virtual line pattern and is preferably printed on the surface of the layer of material. The advantage of this arrangement is that the holographic coded, uniform line pattern always remains the same thus eliminating the cost of creating individualised holograms, and exactly suited hologram-Moiré effects can be integrated in the printed image. With the uniform, line-type hologram virtually coded in front or behind the surface, and the printed image matching up with the lines, almost any Moiré images can be created in the form of positive-negative switch-images.

In the case of a simple arrangement the line-type hologram and the printed image matching up with the lines are essentially identical and are spaced a distance from each other. It is however, also possible for regions of an image to be displaced with respect to the other image e.g. half of the distance between the neighbouring image elements or to provide another image there, with the result that on changing the angle of viewing a multiple light-dark switching effect takes place. Of course images may also contain a combination of straight and curved lines or other image elements. This way it is possible e.g. to incorporate trade marks or the like patterns with three dimensional moiré effect into the packaging material. To increase the proof against forgery further e.g. one of the images may, beside a line-type pattern, also contain an additional structure.

Another way of increasing proof against forgery and for hiding data is by coding additional information in the virtual lines. This additional information can not be decoded without the aid of a “lens” i.e. a uniform image. Such lenses are made up of a grid-like pattern, the grid dimensions of which match the characteristic dimensions of the virtual lines.

In one case the real image is deposited on an opaque film e.g. on an aluminium foil.

Apart from the real and virtual image, a further image may be the mirror image of the real image. In this case the transparent layer of material bearing the printed image borders onto a reflective layer, e.g. an aluminium foil with high gloss surface.

The images may be monochrome or multi-coloured. As an additional precaution colour tones may be employed which create the moiré effect only in ultraviolet or infra red light. Another possibility is to make the real image in the form of a surface structure having parts of its structure at different heights i.e. as an embossed or etched image.

Embossed or etched images are e.g. suitable for production on an aluminium foil. Embossed images may also be produced on plastic or aluminium/plastic laminate films by hot and/or cold embossing. Films or film type laminates with a real image in the form of a surface structure are particularly suitable for the production of tube-shaped laminates e.g. for the manufacture of toothpaste tubes.

The images may also comprise basic matrices with individual elements whereby image elements relating to each other are displaced with respect to each other to create locally different light-dark contrast effects or colours. The image elements preferably form the patterns which, by way of different combinations of superposition yield defined light-dark contrast effects or colours. As these kinds of patterns call for a high degree of accuracy in the super-imposed basic matrices in order to achieve a good image effect, this kind of image is particularly suitable for uses where a high degree of proof against forgery is required.

The production of the item according to the invention takes place using a known method. The proof against forgery is increased in that the application of printed image must be carried out using a machine providing very precise control of the printing process.

The item according to the invention may e.g. be any packaging material in the form of packaging or packaging aid which exhibits a transparent layer of material, whereby additional images according to the invention are applied. The packaging may be rigid, semi-rigid or flexible and may be a shaped body or, in particular, a film-type material. Examples of shaped bodies are blown, deep-drawn and/or stretch-drawn or deepened shaped bodies such as bottles, wide-necked containers, beakers, dishes or base parts of push-through packaging or blister packs. Examples of film-type materials are metal foils, such as aluminium, steel, copper, silver or gold foils. Further examples of film-type materials are papers, such as tissue paper having a unit area weight of 20 to 30 g/m² or highly whitened paper having a weight per unit area of 40 to 60 g/m², cardboard, semi-cardboard or the like. Significant are in particular films containing plastic e.g. on the basis of polyolefins such as polyethylenes or polypropylenes, polyamides, polyvinyl chloride, polyesters such as poly-alkylene-terephthalates and in particular polyethylene-terephthalate. The plastic-containing films may be mono-films of plastics, laminates of two or more plastic films, laminates of metal foils and plastic films, laminates of papers and plastic films or laminates of papers and metal foils and plastic films. The individual plastic films may have a thickness e.g. of 12 to 200μ and the metal foils a thickness of 12 to 100 μm. The individual layers of film-type materials may be attached to each other by means of adhesives, laminate bonding, bonding agents and/or by extrusion coating, co-extrusion or lamination etc. Preferred plastic films are non-oriented or axial or biaxial oriented monofilms or laminates of two or more non-oriented or axial or biaxial oriented films of plastics based on polyolefins such as polyethylenes or polypropylenes, polyamides, polyvinylchloride, polyesters such as polyalkylene-terephthalates and in particular polyethylene-terephthalate.

The above mentioned packaging materials may form the items according to the invention in the form of packaging materials or packaging aids. For example pouches, sachets, wraps, bags etc. may be manufactured from film-type packaging materials by stamping and sealing. Films may shape-formed by deep drawing and/or stretch drawing into shaped packaging or shaped bodies such as base parts of push through or blister packs or wide-necked containers, menu-dishes, goblets, beakers etc. For example tubes (laminate tubes) or lids for shaped forms of packaging may be manufactured from films. For example boxes such as folding boxes may be made from cardboard-containing substances. It is also possible e.g. to employ bottles out of blown plastics or preformed packaging as substrates and to apply the layer of material according to the invention. Closures, openings, seams, seams between a base parts and the related lid etc. may be provided with a packaging aid in the form of a label, sealing strip, ribbon, guarantee seal or an outer closure. As a rule these last mentioned packaging aids are in the form of film materials and are fixed to the container in question over the opening and to the neighbouring container part e.g. by sticking, welding, flanging or shrink fitting etc. The packaging aid exhibits the transparent material layer according to the invention and the image held at a distance by means of this layer. The structure of the surface or a region of the surface according to the invention of the item leads to the desired optical appearance by changing the angle of perception. A forgery by photo-copying and use of the photocopy as a guarantee of originality or manufacture would be instantly and easily recognisable, as changing the angle of perception would not produce the optical effect which results with the structure according to the invention. In order that packaging materials e.g. sealing strips or ribbons can be easily broken by the user, it may be useful to provide aids to tearing such as weaknesses, notches or tear-pull tabs. Also, easy-to-tear or push-through films such as plastic films enriched with filler material or films made from two poorly compatible plastic films my be employed as components of packaging materials or packaging aids.

Apart from the above mentioned use of the item according to the invention in the form of a type of packaging, packaging material or a packaging aid a further field of application is forgery proof production of bonds, tickets for admission and the like documents, whereby apart from the forgery-proofing aspect also special decorative effects can be created.

Further advantages, features and details of the invention are revealed in the following description of preferred exemplified embodiments and with the aid of the drawing which shows schematically in

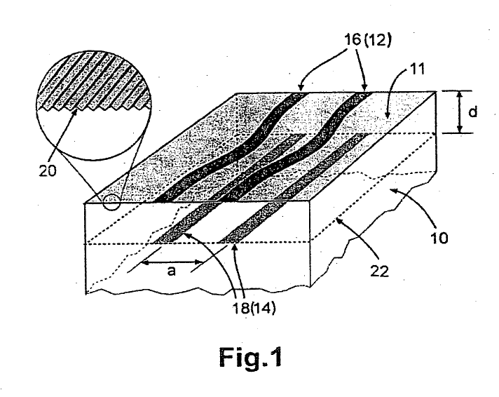

FIG. 1 a perspective view of a virtual coded line-type hologram behind the surface of a layer of material and, on the surface of the layer of material, a printed image which matches the lines.

FIG. 1 shows a transparent layer of material 10 with, printed on the surface 11 of the layer of material 10, a real image 12 and—a distance d from the surface 11—a virtual image 14 holographic coded behind the surface 11 on a virtual image plane 22 parallel to the surface 11 in the form of a series of individual lines 18. The lines 18 of the virtual image 14 are a result of an embossed hologram 20 transferred to surface 11. The image elements 16 of the real image 12 are made to match the lines 18 of the virtual image 14. The distance a between the individual series of lines 18 is in this example always the same and corresponds to the resolution a. Decisive for the three dimensional Moiré effect is the limiting angle αₒ; if it is too large, then a large change in the angle of viewing is necessary to be able to observe the changing Moiré effect i.e. the effect is only slightly noticeable. The optimal value for the limiting angle α₀ is e.g. 20°. The limiting angle αₒ is directly dependant on the distance d between both images 12, 14 and on the resolution a, whereby the following mathematical relationship holds:
a=d·tg αₒ.

On the basis of this mathematical relationship between the distance d between both images 12, 14 and the distance a between the individual lines 16, 18, the distance d between both images 12, 14, it is possible to derive the distance d between both images required to achieve a printed image with optimal resolution a in a simple manner.

The invention is not limited to the examples shown here, but instead includes all items having the material layer of design according to the invention in at least one surface region. In particular, further films or foils may supplement the material layer to provide any kind of packaging material, or the material layer according to the invention may be applied directly to a product.

1. An item with a surface area creating an optical effect to increase protection against forgery, the surface area with the optical effect exhibits at least two images (12, 14) spaced a distance (d) apart and, by changing the angle of viewing (α), the optical perception of the whole image formed by the overlapping of the images (12, 14) changes, whereby a first image (12) is situated on the surface (11) of a layer (10) of material and the images (12, 14) are matched with respect to each other such that they demonstrate Moiré interference effects, the second image (14) is a virtual image that, due to holographic coding, appears to lie a distance (d) from the first image (12).

2. The item according to claim 1, wherein the holographic coding of the second image (14) is an embossed or etched hologram (20).

3. The item according to claim 2, wherein the holographic coded second image (14) is a uniform line pattern and the first image (12) is a pattern which is matched to the uniform line pattern of the second image (14).

4. The item according to claim 3, wherein the first image (12) is printed onto the surface (11) of the layer of material (10).

5. The item according to claim 4, wherein the layer of material (10) is transparent.

6. The item according to claim 5, wherein a shiny layer of aluminum borders on the transparent layer of material (10).

7. The item according to claim 6, wherein at least one image (12, 14) is colored.

8. The item according to claim 7, wherein the first image (12) is a color-printed image which is visible only in ultraviolet or infra-red light.

9. The item according to claim 8, wherein the first image (12) is in the form a surface structure with parts of which are at different heights.

10. The item according to claim 9, wherein the first image (12) is produced as an embossed or etched pattern.

11. The item according to claim 10, wherein the first image (12) is cold and/or hot embossed.

12. The item according to one of the claim 11, wherein areas of one image (14) are displaced with respect to another image (12) in particular by half the distance (a) between neighboring image elements (18).

13. The item according to claim 12, wherein the images (12, 14) comprise a basic matrix with individual image elements, whereby related image elements of different basic matrices are arranged displaced with respect to each other in order to create locally different light-dark contrast effects or colors.

14. The item according to claim 13, the image elements form patterns which, by way of different combinations of superpositions, create defined light-dark contrast effects or colors.

15. The item according to claim 14, wherein the second image (14) contains information which becomes visible only after decoding with a net-like pattern, the dimensions of which are made to match the dimensions of the images (12, 14).

16. A process of utilizing the item according to claim 15, in the form of packaging, packaging material, packaging aid, bonds, entry ticket or the like document with forgery-proof and/or optically demanding surface area.

17. The item according to claim 1, wherein the holographic coded second image (14) is a uniform line pattern and the first image (12) is a pattern which is matched to the uniform line pattern of the second image (14).

18. The item according to claim 1, wherein the first image (12) is printed onto the surface (11) of the layer of material (10).

19. The item according to claim 1, wherein the layer of material (10) is transparent.

20. The item according to claim 19, wherein a shiny layer of aluminum borders on the transparent layer of material (10).

21. The item according to claim 19, wherein a shiny layer of aluminum foil with high gloss surface borders on the transparent layer of material (10).

22. The item according to claim 5, wherein a shiny layer of aluminum foil with high gloss surface borders on the transparent layer of material (10).

23. The item according to claim 1, wherein at least one image (12,14) is colored.

24. The item according to claim 23, wherein the first image (12) is a color-printed image which is visible only in ultraviolet or infra-red light.

25. The item according to claim 1, wherein the first image (12) is in the form a surface structure with parts of which are at different heights.

26. The item according to claim 25, wherein the first image (12) is produced as an embossed or etched pattern.

27. The item according to claim 25, wherein the first image (12) is cold and/or hot embossed.

28. The item according to claim 26, wherein the first image (12) is cold and/or hot embossed.

29. The item according to claim 9, wherein the first image (12) is cold and/or hot embossed.

30. The item according to claim 1, wherein areas of one image (14) are displaced with respect to another image (12) in particular by half the distance (a) between neighboring image elements (18).

31. The item according to claim 1, wherein the images (12, 14) comprise a basic matrix with individual image elements, whereby related image elements of different basic matrices are arranged displaced with respect to each other in order to create locally different light-dark contrast effects or colors.

32. The item according to claim 31, wherein the image elements form patterns which, by way of different combinations of superpositions, create defined light-dark contrast effects or colors.

33. The item according to claim 1, wherein the second image (14) contains information which becomes visible only after decoding with a net-like pattern, the dimensions of which are made to match the dimensions of the images (12, 14).

34. A process of utilizing the item according to claim 1 in the form of packaging, packaging material, packaging aid, bonds, entry ticket or the like document with forgery-proof and/or optically demanding surface area.
